(19) United States
(12) Patent Application Publication
(10) Pub. No.: US 2012/0042396 A1
(43) Pub. Date: Feb. 16, 2012

(54) Methods and Systems for Mobile Device Security

(75) Inventors: Maria Ruth Guerra, Stockholm (SE); Cormac Hegarty, Bromma (SE); Maria Esther Terrero Diaz-Chiron, Madrid (ES)

(73) Assignee: Telefonaktiebolaget L M Ericsson (publ), Stockholm (SE)

(21) Appl. No.: 13/265,645

(22) PCT Filed: Apr. 24, 2009
(86) PCT No.: PCT/EP09/54989

§ 371 Date: Oct. 21, 2011

(51) Int. Cl. G06F 21/24; H04W 12/08; H04W 12/06

(52) U.S. Cl. 726/30

(57) ABSTRACT

A method of securing a mobile wireless telecommunication device to restrict access to data stored in the device. The method including registering the device with a network-based server associated with a given user. In the event that the user wishes to restrict access to data stored on the device when the user does not have access to the device, but has access to an alternative communication device, the user is authenticated, via said alternative communication device, to an IP Multimedia Subsystem (IMS) network and, on the basis of such authentication, the user is allowed to access the server and send to the server an instruction to lock the mobile wireless telecommunication device.

### TECHNICAL FIELD

The present invention relates to mobile device security. More particularly, the invention relates to a method and apparatus for locking, or otherwise restricting access to, a mobile device using an over-the-air locking instruction.

### BACKGROUND

IP Multimedia services provide a dynamic combination of voice, video, messaging, data, etc. within the same session. By growing the number of basic applications and the media which it is possible to combine, the number of services offered to the end users will grow, and the inter-personal communication experience will be enriched. This will lead to a new generation of personalised, rich multimedia communication services, including so-called “combinational IP Multimedia” services.

The UMTS (Universal Mobile Telecommunications System) is a third generation wireless system designed to provide higher data rates and enhanced services to users. UMTS is a successor to the Global System for Mobile Communications (GSM), with an important evolutionary step between GSM and UMTS being the General Packet Radio Service (GPRS). GPRS introduces packet switching into the GSM core network and allows direct access to packet data networks (PDNs). This enables high-data rate packets switch transmissions well beyond the 64 kbps limit of ISDN through the GSM call network, which is a necessity for UMTS data transmission rates of up to 2 Mbps. UMTS is standardised by the 3rd Generation Partnership Project (3GPP) which is a conglomeration of regional standards bodies such as the European Telecommunication Standards Institute (ETSI), the Association of Radio Industry Businesses (ARIB) and others. See 3GPP TS 23.002 for more details.

The UMTS architecture includes a subsystem known as the IP Multimedia Subsystem (IMS) for supporting traditional telephony as well as new IP multimedia services (3GPP TS 22.228, TS 23.228, TS 24.229, TS 29.228, TS 29.229, TS 29.328 and TS 29.329 Releases 5 to 7). IMS provides key features to enrich the end-user person-to-person communication experience through the use of standardised IMS Service Enablers, which facilitate new rich person-to-person (client-to-client) communication services as well as person-to-content (client-to-server) services over IP-based networks. The IMS is able to connect to both PSTN/ISDN (Public Switched Telephone Network/Integrated Services Digital Network) as well as the Internet.

The IMS makes use of the Session Initiation Protocol (SIP) to set up and control calls or sessions between user terminals (or terminals and application servers). The Session Description Protocol (SDP), carried by SIP signalling, is used to describe and negotiate the media components of the session. Whilst SIP was created as a user-to-user protocol, IMS allows operators and service providers to control user access to services and to charge users accordingly. The 3GPP has chosen SIP for signalling between a User Equipment (UE) and the IMS as well as between the components within the IMS.

By way of example, FIG. 1 illustrates schematically how the IMS fits into the mobile network architecture in the case of a GPRS/PS access network (IMS can of course operate over other access networks). Call/Session Control Functions (CSCFs) operate as SIP proxies within the IMS. The 3GPP architecture defines three types of CSCFs: the Proxy CSCF (P-CSCF) which is the first point of contact within the IMS for a SIP terminal; the Serving CSCF (S-CSCF) which provides services to the user that the user is subscribed to; and the Interrogating CSCF (I-CSCF) whose role is to identify the correct S-CSCF and to forward to that S-CSCF a request received from a SIP terminal via a P-CSCF.

Within the IMS service network, Application Servers (ASs) are provided for implementing IMS service functionality. Application Servers provide services to end users in an IMS system, and may be connected either as end-points over the 3GPP defined Mr interface, or “linked in” by an S-CSCF over the 3GPP defined ISC interface. In the latter case, Initial Filter Criteria (IFC) are used by an S-CSCF to determine which Applications Servers should be “linked in” during a SIP Session establishment (or indeed for the purpose of any SIP method, session or non-session related). The IFCs are received by the S-CSCF from an HSS during the IMS registration procedure as part of a user's Subscriber Profile.

In the event that a user of a mobile device looses the device, or the device is stolen or presumed stolen, the user will likely want to have the device disabled to prevent its misuse. In today's networks (e.g. 2G/3G and IMS), a network operator has the possibility to block a SIM/USIM/ISIM card and prevent or limit access to network services from the associated subscription. This is done within the network. Operator initiated SIM/USIM/ISIM blocking will however only prevent use of network services (voice calls, SMS, access to presence information, etc). It does not place any block on access to data stored locally on the device (e.g. private phone book, picture library, sent SMSs, call history, etc). Moreover, such blocking will prevent a user from accessing network services from any device associated with the subscription. This is undesirable as future service models (e.g. IMS based) rely upon subscribers making use of multiple access devices to access network services. For example a user may have a 2G/3G device and one or more devices connected to a broadband network (e.g. via a home gateway).

In addition to the inconvenience to a user when one or all of his or her devices are effectively blocked from accessing network services, there are significant cost issues with this approach. If a SIM/USIM/ISIM card is blocked (which means that even if found again, the SIM card cannot be used), a new SIM card has to be sent to the customer and network parameters have to be re-set.

### SUMMARY

It is an object of the present invention to overcome or at least mitigate the problems considered above. In particular, it is an object to provide a mechanism for locking, or otherwise restricting access to, a mobile device using an over-the-air locking instruction and which is specific to a given user device.

According to a first aspect of the present invention there is provided a method of securing a mobile wireless telecommunication device to prevent or restrict access to data stored in the device. The method comprises firstly registering the device with a network-based server in respect of a given user. In the event that said user wishes to prevent or restrict access to data stored on the device when the user does not have access to the device but has access to an alternative communication device, the following steps are carried out. The user is authenticated, via said alternative communication device, to an IP Multimedia Subsystem network, and, on the basis of such authentication, the user is allowed to access the server and send to the server an instruction to lock said mobile wireless telecommunication device.

Upon receipt of said instruction at the server, a lock instruction is caused to be sent over the air to said mobile wireless telecommunication device, the instruction containing an unlocking code. The lock instruction is received at the device, causing the device to be locked. Additionally, the unlocking code is sent from the server to said alternative communication device. The mobile wireless telecommunication device can only be unlocked by a user entering said unlocking code.

Embodiments of the invention provide a mechanism for reducing the risk that sensitive data held on a mobile device can be accessed by an unauthorised party. The mechanism effectively piggybacks on an available IMS authentication procedure so the impact on the network is minimised.

The mobile wireless telecommunication device may comprise an IP Multimedia Subsystem client for interacting with said IP Multimedia Subsystem network. In this case, said step of causing a lock instruction to be sent over the air to said mobile wireless telecommunication device comprises sending a Session Initiation Protocol message, containing the lock instruction, from the network to the mobile wireless telecommunication device.

The step of registering the device with a network-based server in respect of a given user may comprise registering a Globally Routable User Agent URI assigned to the mobile wireless telecommunication device. The Session Initiation Protocol message is routed to the mobile wireless telecommunication device using the registered Globally Routable User Agent URI.

The method may comprise including in said Session Initiation Protocol message, an IMS Application Reference ID (e.g. an IARI) identifying a locking application, wherein it is that locking application that performs, within the device, the step of causing the device to be locked. In this case, the step of registering the device with a network-based server in respect of a given user may comprise registering at the server the IMS Application Reference ID.

The step of registering the device with a network-based server in respect of a given user may comprise performing an IMS registration between a Serving Call Session Control Function and performing a third party registration between the Serving Call Session Control Function and said network-based server. In this case, a SIP REGISTER message sent from the mobile wireless telecommunication device to the Serving Call Session Control Function may include a device name, e.g. a user entered nickname. The device name is further included in a SIP REGISTER sent from the Serving Call Session Control Function to the network-based server. The device name may be incorporated into one of an Instance ID and an IMS Application Reference ID of the SIP REGISTER message(s).

The mobile wireless telecommunication device may comprise a 2G or 3G radio interface, in which case said step of causing a lock instruction to be sent over the air to said mobile wireless telecommunication device may comprise including the instruction in a Short Message Service message.

The step of registering the device with a network-based server in respect of a given user may comprise establishing a shared authentication key between the mobile wireless telecommunication device and said server. This key or a derivative of the key is sent with said lock instruction to allow the mobile wireless telecommunication device to authenticate the server as the source of the instruction.

The network-based server may be a SIP Application Server, for example dedicated to providing the security (locking) service. It may be within, or outside of, the IMS network.

According to a second aspect of the present invention there is provided a server for use within, or having access to, an IP Multimedia Subsystem. The server comprises a user registration unit for registering mobile wireless telecommunication devices to respective users, and a receiver for receiving from a client terminal registered with the IP Multimedia Subsystem, via said IP Multimedia Subsystem, an instruction to lock a mobile wireless telecommunication device registered for that user. The server further comprises a sender for sending or causing to be sent, upon receipt of said instruction, a lock instruction over the air to said mobile wireless telecommunication device, the instruction containing an unlocking code.

The server according to the invention has the advantage that it provides an interface over which a user can lock specific devices, relying upon a pre-existing IMS authentication mechanism.

The user registration unit may be being configured to receive a third party registration request from a Serving Call Session Control Function in respect of a user, and to register for that user a device name allocated to said mobile wireless telecommunication device. This device name may be incorporated into one of an Instance ID and an IMS Application Reference ID contained in the third party registration request.

According to a third aspect of the present invention there is provided a mobile wireless telecommunication device comprising a registration unit for registering the device with a network-based server, in respect of a given user, and a receiver for receiving a lock instruction from the server, the instruction containing an unlocking code. The device further comprises a locking unit for causing the device to be locked upon receipt and authentication of the lock instruction, and for unlocking the device upon the user input to the device of said unlocking code.

The device according to the invention is thus provided with an improved security mechanism that allows it to be unlocked remotely by the device owner, without necessarily affecting other devices associated with the same subscription.

The registration unit may be configured to perform the registration at first power-up of the device, and/or to perform said registration by way of a registration to an IP Multimedia Subsystem. In the latter case, the registration unit may be configured to include a device name in a SIP REGISTER message sent to the IP Multimedia Subsystem network. The device name may be a user entered device name.

The device name may be included in the SIP REGISTER message by incorporation into one of an Instance ID and an IMS Application Reference ID.

### BRIEF DESCRIPTION OF THE DRAWINGS

FIG. 1 illustrates schematically an IMS network integrated into a 2G/3G telecommunications system;

FIG. 2 illustrates schematically a multi-access network architecture for accessing IMS services;

FIG. 3 illustrates a procedure for registering a mobile device with an IMS-based locking service, and for subsequently locking that device;

FIG. 4 is a flow diagram further illustrating the procedure of FIG. 3

FIG. 5 illustrates schematically the main functional components of a SIP Application Server providing a security service to IMS subscribers; and

FIG. 6 illustrates schematically a mobile device configured for use with the service illustrated in FIG. 3.

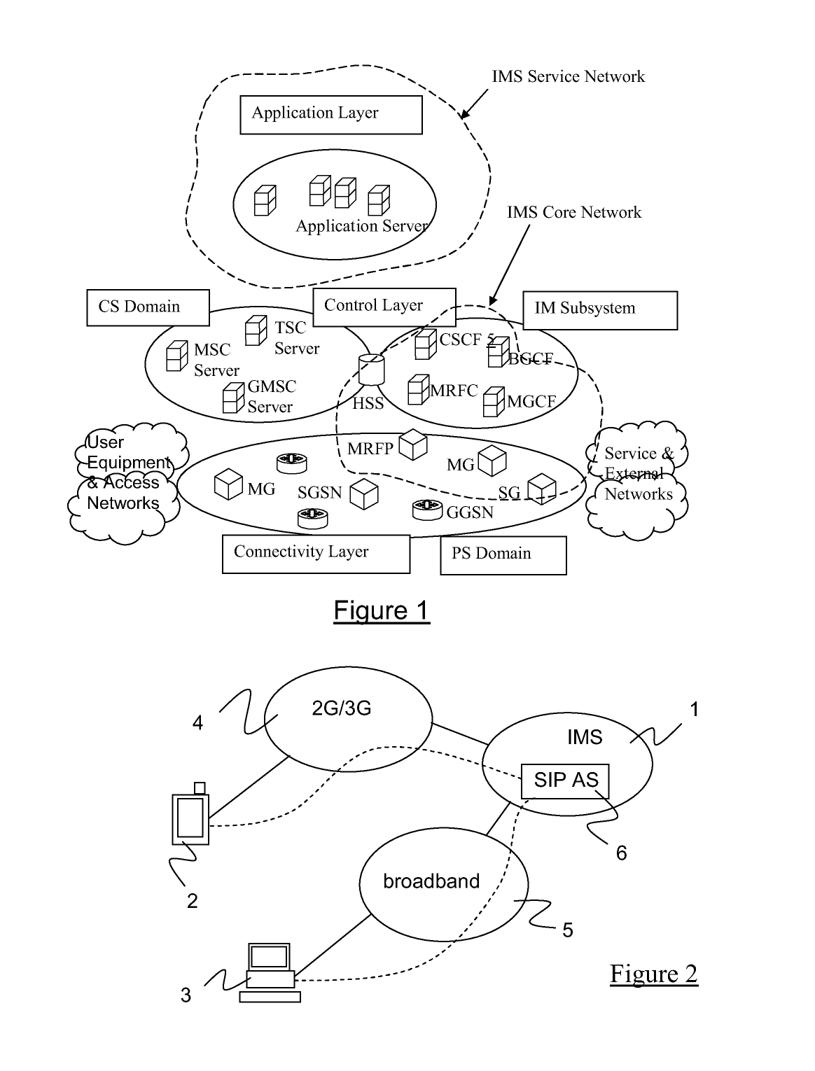

### DETAILED DESCRIPTION

There is illustrated in FIG. 2 a multi-access network architecture for accessing IP Multimedia Subsystem (IMS) services provided by an IMS network 1. By way of example, the Figure shows a pair of user terminals including a mobile 2G/3G device 2 and a Personal Computer (PC) 3. The mobile device 2 is able to access the IMS via a 2G/3G wireless access network 4, and comprises an IMS client. Of course, the device 2 may also access other non-IMS services via the 2G/3G access network including, for example, voice calls, web browsing, etc. The PC 3 on the other hand accesses the IMS network via a wired broadband network 5. This requires that the user perform IMS registration, using for example a username and password, via a web interface.

FIG. 2 also shows a SIP Application Server AS 6 within the IMS network. This SIP AS functions as a security AS. The SIP AS has an interface to one or more Call Session Control Functions (CSCFs) within the IMS that allow it to interact with devices comprising an IMS client, such as the mobile device 2. The SIP AS also has an http interface that allows it to be accessed via the Internet. The SIP AS 6 provides novel security functionality to IMS subscribers as will now be described.

It is proposed here to allow an IMS subscriber to control access to his or her registered devices via a web page accessed over the Internet and to which access is granted through IMS-based user authentication. This will allow a lost or stolen device to be selected and locked. When the stolen/lost device is selected to be locked, the subscriber is presented with an automatically generated pin code which can later be used to unlock the device if and when it is located. When a device is locked, no access is given to the menu system of the device (thus hiding the user's sensitive private data), other than to allow entry of the unlocking code. Switching off of the locked device will not be allowed in order to allow tracking of the terminal (until it runs out of battery).

Device security is facilitated by a dedicated security application that is installed on the device. JSR281 “IMS Service APIs” standards can be used to develop the security application. When a mobile device (with this security application installed) is acquired by a subscriber (or such a security application is downloaded and installed onto the device), at first power-on the user will be requested to enter a “nickname” for the device (e.g. My_Work_Phone). At this time the user is also asked to provide a secret key. The nickname is registered with the SIP AS 6 in the IMS network together with a unique identity (or Instance ID) of the device. This instance ID may be, for example, an IMSI or MAC address of the device. In normal use, access to the device (both services and data) is locked either on demand by the user, or after a timeout period has elapsed, e.g. 2 minutes. In either case, access can only be obtained by entering the secret key stored on, or otherwise known, to the device. Locking may involve encrypting sensitive user data.

The security application may not by itself prevent someone who has stolen (or otherwise finds) the device from accessing data stored on the device. For example, if the device is unlocked when it is stolen, the thief may immediately over-ride the locking mechanism to disable it. Therefore, an extra service to lock the device from the network is added.

If the user loses the mobile device 2 illustrated in FIG. 2, she/he connects to the web page using an alternative communication device such as PC 3, and selects the missing device based on the device's nickname. This involves performing an IMS authentication process. The SIP AS 6 will associate the selected device nickname with a specific device. The SIP AS 6 has access to this information based on the earlier registration performed by the subscriber. A specific message will be sent to the terminal (with an automatically generated pin code), and it will be locked. The SIP AS may make use of the 3GPP IMS Globally Routable User Agent URI (GRUU) functionality in order to route the locking request to the specified device. The GRUU may be a Public GRUU (P-GRUU) derived by the S-CSCF at registration on the basis of the Instance ID provided by the device. If and when the device is subsequently unlocked by the user, it should send a message to the IMS network informing the network that the device has been unlocked. If the device has already received a locking order and a further locking order is received, the second order shall be ignored.

Considering now the security application installed in the mobile device, this shall perform the following functions:
At first power-on, request the user to input a device nickname that will allow the user to memorably identity the device. This assumes that the device has earlier performed IMS registration based upon an IMS Public User Identity (IMPU), and has indicated to the IMS network that the device supports GRUU functionality.
Request the user to provide a secret key to encrypt at least sensitive data in the device (e.g. contact list, . . . ). This secret key will be requested at least every time the terminal is switched-on.
Register with the SIP AS: 1) the device nickname, 2) a device ID, and 3) an application identity that identifies the security application on the device. As already mentioned, the device ID may be a GRUU, whilst the application reference identity may be an IARI.
Receive in response to the registration a random value. This allows the device to later authenticate a locking instruction received from the network.
Lock the device when a SIP INVITE is received including a value obtained by hashing the random number with the device ID, and the appropriate IARI. These values may be contained the Accept-Contact or P-Preferred-Service header.
Store an unlocking code contained within an XML body of the received SIP INVITE.

The new functionality implemented at the SIP AS is required to perform the following:
Manage a list of device nicknames and device ID's (received in the third party Register) which can be locked by a subscriber over a GUI or Ut interface.
Implement policies to determine which method to use to send the locking message, based on HSS information (for example is the device attached to GSM/UMTS/IMS). This may involve retrieving a telephone number (MSISDN) for the device in the case where the device only has 2G/3G access.
Enforce policies based on the decision, e.g. if only GSM/GPRS/UMTS is available, send SMS to lock device, or if IMS is available, send a SIP INVITE to lock the device. This INVITE may be a “Call-Out-Of-The-blue” INVITE.
On a locking order from the subscriber, a pin code is randomly generated and returned to the subscriber via the web interface.

It is expected that the approach described here can be introduced without requiring significant changes to the IMS nodes (other than the security SIP AS). In particular, the S-CSCF allocated to a subscriber generates the T-GRUU and the P-GRUU at registration according to 3GPP standards and sends them as part of a third party registration process to the SIP AS that manages the security service (and identified to the S-CSCF by the HSS). The S-CSCF also sends to the SIP AS the device nickname (given at initial registration), as an extension of the Instance ID or the identification of the security application (e.g. IARI). Of course, the S-CSCF is not required to know that the Instance ID or the IARI includes the nickname, and it can effectively be transported transparently through the S-CSCF.

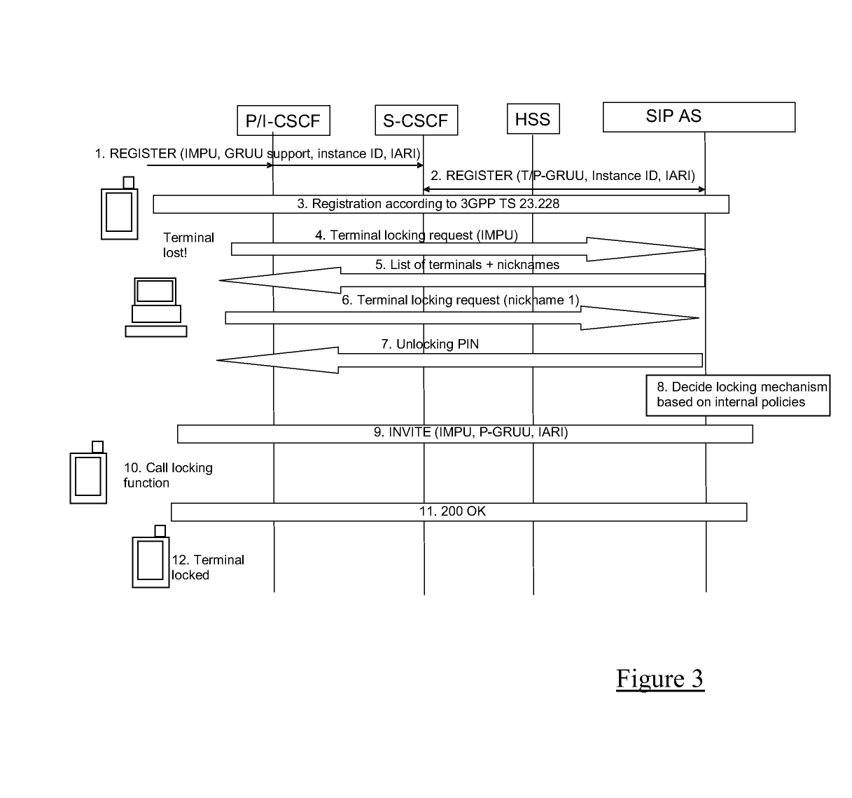

FIG. 3 illustrates the process for firstly registering a mobile device with an IMS-based SIP AS, steps 1 to 3. Step 1 may be a standard IMS registration process by means of which the device initiates registration with the IMS and all appropriate services. Upon discovering that the device has been lost or stolen, the user registers with the IMS via an alternative device, and requests at step 4 a locking action. At steps 5 to 7, the user selects the device using the previously specified nickname and receives the locking PIN. At step 8 the AS selects the locking mechanism to be employed, in this example routing a SIP INVITE using the device's registered P-GRUU, and sends the INVITE at step 9. At steps 10 to 12, the device receives and acknowledges the lock instruction, and locks the device.

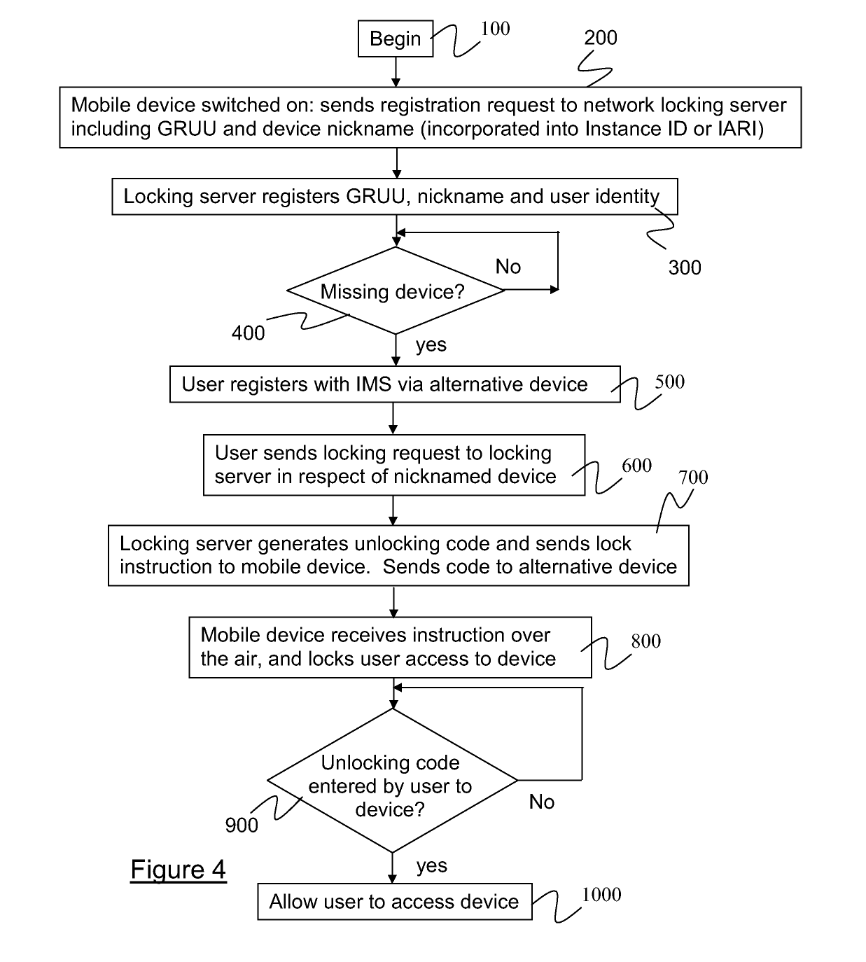

FIG. 4 is a flow diagram further illustrating the procedure of FIG. 3. The process begins at step 100, for example with the acquisition of a new IMS-enabled terminal by a subscriber of a 2G/3G network. At step 200, the subscriber switches on the device for the first time, causing the device to register with the SIP AS including providing to the SIP AS a device nickname and device GRUU, step 300. If the user believes that the device has been lost or stolen at step 400, the user registers to the IMS network via a web interface, e.g. using a PC, step 500. Via the web interface, at step 600, the user selects the device using the registered nickname, and requests the IMS service to lock the missing device. At step 700, the security AS generates an unlocking code (e.g. 10 digits), and includes this in a lock instruction that is sent to the mobile device. This may be routed using a registered GRUU, or using an MSISDN (e.g. where the message is an SMS message). The SIP AS also sends the unlocking code to the PC, via the web interface. At step 800, the missing mobile device receives the lock instructions, authenticates the instruction, and then immediately locks the device. If the device is subsequently found by the subscriber and the unlocking code correctly entered, step 900, the device is unlocked at step 1000.

FIG. 5 illustrates schematically the main functional components of the SIP AS 6. These components are: a user registration unit 7 that handles user device registration including registering for each device a GRUU and a device nickname; a receiver 8 that interacts with an alternative user device such as a PC via a web interface, and retrieves data from the user registration unit; and a sending unit 9 responsive to an instruction received from the receiver 8 to send a lock instruction to a mobile device. It is the receiver 8 that is responsible for generating the unlocking code.

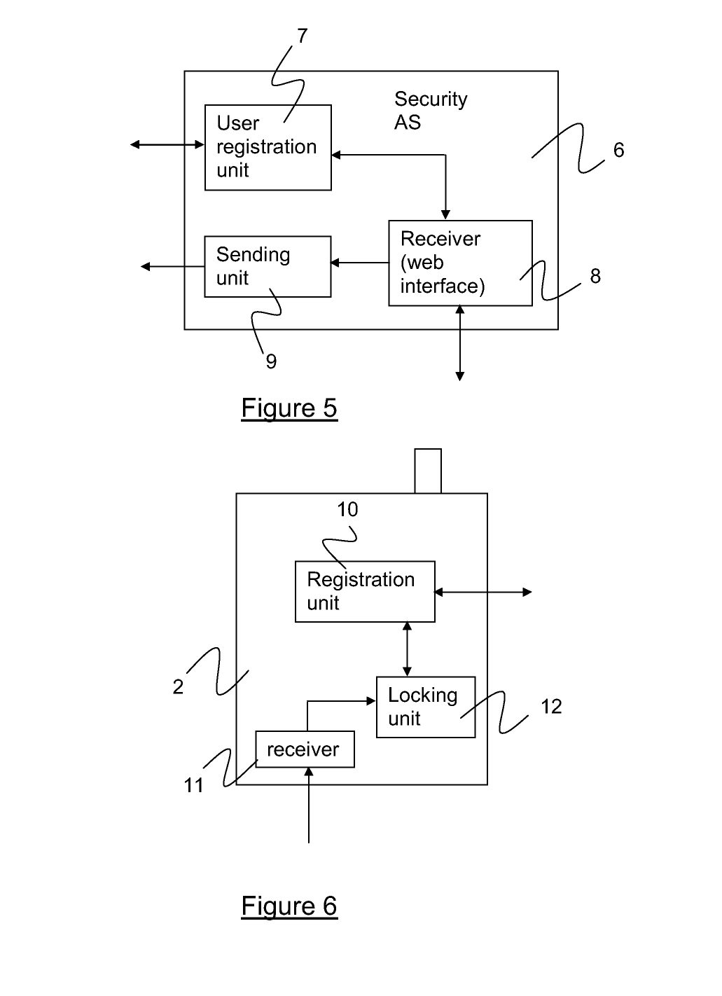

FIG. 6 illustrates schematically a mobile device 2 that is assumed to comprise a 2G/3G radio interface and associated functionality, as well as an IMS client. In addition, the device comprises a registration unit 10 configured to register the device with an IMS based security service as described above, and a receiver 11 for receiving a lock instruction from the locking service. Any such instruction is passed to a locking unit 12 which supports a security application. This application is responsible for both authenticating the received instruction and locking the device until such time as a correct unlocking code is entered. Additionally, the security application handles “normal” locking procedures including those associated with power-on and time-outs.

It will be appreciated by the person of skill in the art that various modifications may be made to the above described embodiments without departing from the scope of the present invention. For example, whilst the embodiment described above makes use of a SIP AS that is within an operator's IMS network, this need not be the case. The SIP AS may be a SIP AS that is owned and operated by a third party that provides the new locking service over and above the services provided to subscribers by the IMS network operator.

1. A method of securing a mobile wireless telecommunication device to prevent or restrict access to data stored in the device, the method comprising:
registering the device with a network-based server in respect of a given user;
in the event that said user wishes to prevent or restrict access to data stored on the device when the user does not have access to the device but has access to an alternative communication device,
authenticating the user, via said alternative communication device, to an IP Multimedia Subsystem network,
on the basis of such authentication, allowing the user to access the server and sending from said alternative communication device to the server an instruction to lock said mobile wireless telecommunication device,
upon receipt of said instruction at the server, causing a lock instruction to be sent over the air to said mobile wireless telecommunication device, the instruction containing an unlocking code,
receiving said lock instruction at the device, causing the device to be locked,
sending the unlocking code from the server to said alternative communication device,
wherein, the mobile wireless telecommunication device can only be unlocked by a user entering said unlocking code.

2. A method according to claim 1, wherein said mobile wireless telecommunication device comprises an IP Multimedia Subsystem client for interacting with said IP Multimedia Subsystem network, and said step of causing a lock instruction to be sent over the air to said mobile wireless telecommunication device comprises sending a Session Initiation Protocol message, containing the lock instruction, from the network to the mobile wireless telecommunication device.

3. A method according to claim 2, said step of registering the device with a network-based server in respect of a given user comprising registering a Globally Routable User Agent URI assigned to the mobile wireless telecommunication device, wherein said Session Initiation Protocol message is routed to the mobile wireless telecommunication device using the registered Globally Routable User Agent URI.

4. A method according to claim 2 or 3 and comprising including in said Session Initiation Protocol message, an IMS Application Reference ID identifying a locking application, wherein it is that locking application that performs, within the device, the step of causing the device to be locked.

5. A method according to claim 4, said step of registering the device with a network-based server in respect of a given user comprising registering at the server the IMS Application Reference ID.

6. A method according to any one of the preceding claims, said step of registering the device with a network-based server in respect of a given user comprising performing an IMS registration between a Serving Call Session Control Function and performing a third party registration between the Serving Call Session Control Function and said network-based server.

7. A method according to claim 6 and comprising including in a SIP REGISTER message sent from the mobile wireless telecommunication device to the Serving Call Session Control Function a device name, and further including this device name in a SIP REGISTER sent from the Serving Call Session Control Function to the network-based server.

8. A method according to claim 7, wherein, said device name is a user entered device name.

9. A method according to claim 7 or 8 and comprising incorporating said device name into one of an Instance ID and an IMS Application Reference ID.

10. A method according to claim 1, said mobile wireless telecommunication device comprising a 2G or 3G radio interface and said step of causing a lock instruction to be sent over the air to said mobile wireless telecommunication device comprising including the instruction in a Short Message Service message.

11. A method according to any one of the preceding claims, said step of registering the device with a network-based server in respect of a given user comprising establishing a shared authentication key between the mobile wireless telecommunication device and said server, this key or a derivative of the key being sent with said lock instruction to allow the mobile wireless telecommunication device to authenticate the server as the source of the instruction.

12. A method according to any one of the preceding claims, wherein said network-based server is a SIP Application Server.

13. A server for use within, or having access to, an IP Multimedia Subsystem and comprising:
a user registration unit for registering mobile wireless telecommunication devices to respective users;
a receiver for receiving from a client terminal registered with the IP Multimedia Subsystem, via said IP Multimedia Subsystem, an instruction to lock a mobile wireless telecommunication device registered for that user; and
a sender for sending or causing to be sent, upon receipt of said instruction, a lock instruction over the air to said mobile wireless telecommunication device, the instruction containing an unlocking code.

14. A server according to claim 13, said user registration unit being configured to receive a third party registration request from a Serving Call Session Control Function in respect of a user, and to register for that user a device name allocated to said mobile wireless telecommunication device.

15. A server according to claim 14, wherein said device name is incorporated into one of an Instance ID and an IMS Application Reference ID contained in the third party registration request.

16. A mobile wireless telecommunication device comprising:
a registration unit for registering the device with a network-based server, in respect of a given user;
a receiver for receiving a lock instruction from the server, the instruction containing an unlocking code,
a locking unit for causing the device to be locked upon receipt and authentication of the lock instruction, and for unlocking the device upon the user input to the device of said unlocking code.

17. A device according to claim 10 or 11, said registration unit being configured to perform the registration at first power-up of the device.

18. A device according to claim 16 or 17, said registration unit being configured to perform said registration by way of a registration to an IP Multimedia Subsystem.

19. A device according to claim 18, said registration unit being configured to include a device name in a SIP REGISTER message sent to the IP Multimedia Subsystem network.

20. A device according to claim 19, wherein said device name is a user entered device name.

21. A device according to claim 19 or 20, wherein said device name is included in the SIP REGISTER message by incorporation into one of an Instance ID and an IMS Application Reference ID.
